(19) United States
(12) Patent Application Publication
(10) Pub. No.: US 2021/0331815 A1
(43) Pub. Date: Oct. 28, 2021

(54) METHOD FOR CONTROLLING GAP DISTRIBUTION OF WING-FUSELAGE JOINING BASED ON MEASURED DATA

(71) Applicant: NANJING UNIVERSITY OF AERONAUTICS AND ASTRONAUTICS, Nanjing (CN)

(72) Inventors: Jun WANG, Nanjing (CN); Zeyong WEI, Nanjing (CN); Yan WANG, Nanjing (CN); Honghua CHEN, Nanjing (CN)

(21) Appl. No.: 17/169,521

(22) Filed: Feb. 7, 2021

(30) Foreign Application Priority Data
Apr. 27, 2020 (CN) 202010343957.1

(51) Int. Cl. B64F 5/10; G06F 30/15

(52) U.S. Cl. CPC B64F 5/10; G06F 30/15

(57) ABSTRACT

A method for controlling a gap distribution of a wing-fuselage joining based on measured data, in which original point cloud data of a wing and a central wing box are respectively collected, and then preprocessed. The preprocessed point cloud data of the wing and the center wing box are registered with the corresponding theoretical models. The key features during joining on the two theoretical models are selected. The the key features are mapped to the registered point cloud data, and the corresponding point cloud features are extracted. The point cloud data of the wing and the point cloud data of the central wing box are docked based on the positioning points. The joining surface is divided into multiple areas, and the gap between the feature points of each area after joining is calculated. According to the gap tolerance, the weight of each area is adjusted to control the gap distribution.

### CROSS-REFERENCE TO RELATED APPLICATIONS

This application claims the benefit of priority from Chinese Patent Application No. 202010343957.1, filed on Apr. 27, 2020. The content of the aforementioned application, including any intervening amendments thereto, is incorporated herein by reference in its entirety.

### TECHNICAL FIELD

The present application relates to aviation manufacturing, and more particularly to a method for controlling a gap distribution of a wing-fuselage connection based on measured data.

### BACKGROUND

In the aircraft assembly, the size of the jointing gap between the various parts of the aircraft is an important indicator of the quality of the assembly. In the modern assembly process, a method is also provided for selecting multiple parts of the same type to connect with the whole body of the aircraft, and selecting the best part for assembly, which helps to improve an overall assembly quality of the aircraft.

However, in the method, the parts need to be disassembled and assembled many times, which seriously affects the production speed. In addition, a feeler gauge is adopted manually to measure and control the gap, which has some following drawbacks. The manual measurement with feeler gauge consumes a lot of labor. The measurement result depends on the professional quality of the staff, which will be affected by the subjective influence of the staff. Moreover, since many positions are difficult to measure, only a few measuring points are measured, which cannot reflect an overall gap of the joining surface. Therefore, it is urgent to propose a new method for controlling the gap distribution, to replace the traditional control method for gap measurement, thereby improving product accuracy and production efficiency, and promoting the digital management of measurement data.

### SUMMARY

An object of the present disclosure is to provide a method for controlling a gap distribution of a wing-fuselage joining based on measured data, which can control the gap distribution of the wing-fuselage joining through feature weights based on the measured data to satisfy the gap requirements during wing fuselage assembly, thereby improving assembly quality and production efficiency of the wing fuselage, and meeting the technical requirements for controlling the gap distribution of the wing-fuselage joining.

To achieve the above-mentioned object, the present disclosure provides a method for controlling a gap distribution of a wing-fuselage joining based on measured data, comprising:

S1) respectively collecting original point cloud data of a wing and original point cloud data of a central wing box of an aircraft;

S2) preprocessing the original point cloud data of the wing and the original point cloud data of the central wing box; performing operations of denoising, filtering and sparsification; and removing point cloud data that does not belong to joining surface between the wing and the central wing box;

S3) respectively registering the preprocessed point cloud data of the wing and the preprocessed point cloud data of the center wing box with corresponding theoretical models;

S4) according to a simulated joining situation of an entity model of the wing and a simulated joining situation of an entity model of the central wing box; selecting key features during joining on the two theoretical models; mapping the key features to the registered point cloud data; and extracting corresponding point cloud features, wherein the key features comprise positioning points and feature points of the joining surface;

S5) joining the point cloud data of the wing and the point cloud data of the central wing box based on the positioning points; and

S6) dividing the joining surface into a plurality of areas; calculating a gap between the feature points in each of the plurality of areas after joining; adjusting a weight of each of the plurality of areas according to gap tolerance to control the gap distribution; wherein the weight of each of the plurality of areas is inversely proportional to the gap tolerance thereof.

In an embodiment, a process of respectively collecting original point cloud data of the wing and original point cloud data of the central wing box of the aircraft in step S1 comprises:

S11) pasting code points and gauge points around the joining surface; S12) obtaining coordinate information of the code points and the gauge points by using a photogrammetry technology, and establishing a scanning control field according to the obtained coordinate information;

S13) scanning the wing and the central wing box with a scanner to obtain the corresponding original point cloud data; and

S14) by combining with the scanning control field established in step S12, performing point cloud refinement on the original point cloud data of the wing fuselage and the original point cloud data of the central wing box to enhance a detailed description.

In an embodiment, a process of preprocessing the original point cloud data of the wing and the original point cloud data of the central wing box comprises:

S21) processing the original point cloud data through Gaussian filtering to remove noise and outliers, and extracting points belonging to the joining surface between the wing and the central wing box; and

S22) performing sparsification on the extracted points based on curvature.

In an embodiment, a process of performing sparsification on the extracted points based on curvature comprises:

S221) for a point xᵢ in the point cloud data, defining a point set of a neighborhood of the point as Xᵢ, wherein xⱼ∈Xᵢ; 1≤j≤n, n is the number of points in the point set of the neighborhood; and calculating an average curvature Qᵢ of the point xᵢ based on the point set Xᵢ of the neighborhood;

for the point xᵢ and the point set Xᵢ of the neighborhood, calculating an average value Pᵢ of the average curvature Qᵢ according to the following formula:

$${P}_{i} = \frac{1}{n} {\sum }_{j = 1}^{n} {Q}_{j} ;$$

wherein Qⱼ is an average curvature of a point xⱼ in the point set Xᵢ of the neighborhood of the point xᵢ;

S222) calculating an error φᵢ of a local average curvature according to the following formula:

$${φ}_{i} = {\sum }_{j = 1}^{n} \sqrt{\frac{{( {Q}_{j} - {P}_{i} )}^{2}}{n - 1}} ;$$

and setting an error threshold E of the local average curvature;

S223) setting a corresponding retention time F and a calculation time S for each of points in the point cloud data;

S224) for the point xᵢ, if φᵢ≥ε, retaining a point with an average curvature Qⱼ≥λPᵢ in the point set Xᵢ of the neighborhood of the point xᵢ, wherein λ is a preset value; if φᵢ<ε, retaining a point where an average curvature Qⱼ thereof is closest to the average value Pᵢ of the curvature average in the point set Xᵢ of the neighborhood of the point xᵢ; increasing the retention number of the retained points cumulatively by 1 (Fⱼ=Fⱼ+1), and increasing the calculation number of all points in the point set of the neighborhood by 1 (Sⱼ=Sⱼ+1);

S225) repeatedly processing step S224 until all points are processed; calculating a reduction probability θ of each of points according to the following formula:

θ=Fᵢ/Sᵢ;

processing all point cloud data according to the reduction probability of each of points; if a reduction probability of a point is greater than or equal to 0.5, retaining the point; if a reduction probability of a point is less than 0.5, deleting the point.

In an embodiment, a process of respectively registering the preprocessed point cloud data of the wing and the preprocessed point cloud data of the center wing box with the corresponding theoretical models comprises:

S31) respectively extracting part of or all of the positioning points corresponding to the theoretical models of the wing and the central wing box in the point cloud data;

S32) based on the singular value decomposition (SVD) algorithm, respectively calculating a transformation matrix from the positioning point of the wing in the point cloud data to the positioning point of corresponding entity model, and a transformation matrix from the point cloud data positioning point of the central wing box to the corresponding entity model positioning point;

for the point xᵢ and the point set Xᵢ of the neighborhood, calculating an average value Pᵢ of the average curvature Qᵢ according to the following formula:

$${P}_{i} = \frac{1}{n} {\sum }_{j = 1}^{n} {Q}_{j} ;$$

wherein Qⱼ is an average curvature of a point xⱼ in the point set Xᵢ of the neighborhood of the point xᵢ;

S222) calculating an error φᵢ of a local average curvature according to the following formula:

$${φ}_{i} = {\sum }_{j = 1}^{n} \sqrt{\frac{{( {Q}_{j} - {P}_{i} )}^{2}}{n - 1}} ;$$

and setting an error threshold E of the local average curvature;

S223) setting a corresponding retention time F and a calculation time S for each of points in the point cloud data;

S224) for the point xᵢ, if φᵢ≥ε, retaining a point with an average curvature Qⱼ≥λPᵢ in the point set Xᵢ of the neighborhood of the point xᵢ, wherein λ is a preset value; if φᵢ<ε, retaining a point where an average curvature Qⱼ thereof is closest to the average value Pᵢ of the curvature average in the point set Xᵢ of the neighborhood of the point xᵢ; increasing the retention number of the retained points cumulatively by 1 (Fⱼ=Fⱼ+1), and increasing the calculation number of all points in the point set of the neighborhood by 1 (Sⱼ=Sⱼ+1);

S225) repeatedly processing step S224 until all points are processed; calculating a reduction probability θ of each of points according to the following formula:

θ=Fᵢ/Sᵢ;

processing all point cloud data according to the reduction probability of each of points; if a reduction probability of a point is greater than or equal to 0.5, retaining the point; if a reduction probability of a point is less than 0.5, deleting the point.

In an embodiment, a process of respectively registering the preprocessed point cloud data of the wing and the preprocessed point cloud data of the center wing box with the corresponding theoretical models comprises:

S31) respectively extracting part of or all of the positioning points corresponding to the theoretical models of the wing and the central wing box in the point cloud data;

S32) based on the singular value decomposition (SVD) algorithm, respectively calculating a transformation matrix from the positioning point of the wing in the point cloud data to the positioning point of corresponding entity model, and a transformation matrix from the point cloud data positioning point of the central wing box to the corresponding entity model positioning point;

### BRIEF DESCRIPTION OF THE DRAWINGS

The drawings are not intended to be drawn to scale. In the drawings, each identical or nearly identical component shown in each drawing may be represented by the same reference numeral. For clarity, not every component is labeled in all drawing. The embodiments of the present disclosure in various aspects will be described by way of examples and with reference to the drawings, in which:

FIG. 1 is a flowchart of a method for controlling a gap distribution of a wing-fuselage joining based on measured data according to an embodiment of the present disclosure.

FIG. 2 is a schematic diagram of pasting code points of the wing according to an embodiment of the present disclosure.

FIG. 3 is a schematic diagram of point cloud data of the wing according to an embodiment of the present disclosure.

FIG. 4 is a schematic view of a joining surface of a central wing box according to an embodiment of the present disclosure.

FIG. 5 is a schematic diagram of a weight distribution of a joining surface area of the wing according to an embodiment of the present disclosure.

FIG. 6 is a schematic diagram of a gap between the wing and the central wing box according to an embodiment of the present disclosure.

### DETAILED DESCRIPTION OF EMBODIMENTS

In order to better understand the technical content of the present invention, specific embodiments are described below in conjunction with the accompanying drawings.

Referring to FIG. 1, the embodiment provides a method for controlling a gap distribution of a wing-fuselage joining based on measured data, including the following steps.

S1) The original point cloud data of a wing and original point cloud data of a central wing box of an aircraft are respectively collected by cooperating photogrammetry with a scanner.

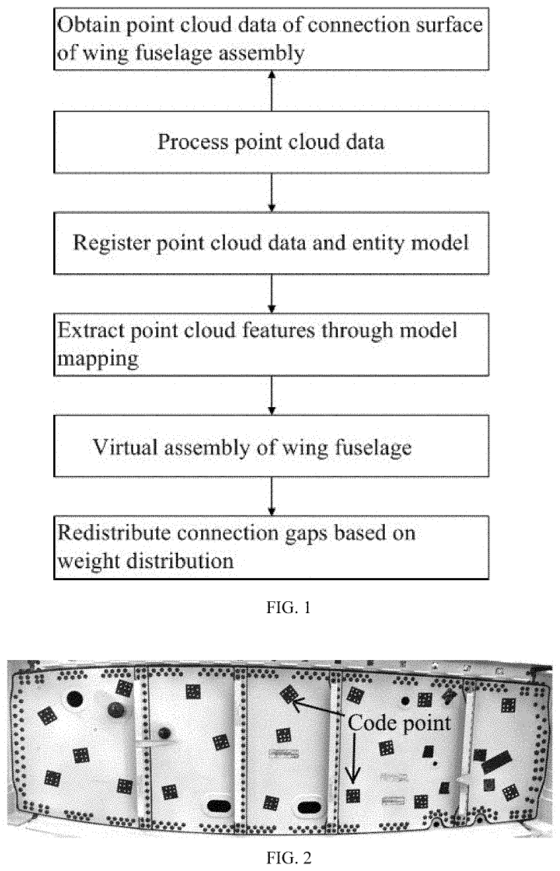

Firstly, the code points and gauge points are pasted around the joining surface of aircraft wing fuselage respectively, the coordinate information of the code points and gauge points on the wing fuselage are obtained by using a photogrammetry technology to establish a scanning control field. And then the wings and the central wing box are scanned respectively by using the scanner, to obtain the point cloud data. The point cloud data are added to the control field established by photogrammetry, to enhance the detailed description. The pasting of code points is shown in FIG. 2.

S2) The original point cloud data of the wing and the original point cloud data of the central wing box are preprocessed, and operations of denoising, filtering and sparsification are performed.

The point cloud data obtained by the scanner contains some worthless noise points and outliers, which can be removed by Gaussian filtering. The points that do not belong to the joining surface of the wing and the central wing box are divided by using point cloud segmentation, and only the points belonging to the joining surface of the wing and the central wing box are retained. FIG. 3 shows the point cloud data of the wing after segmentation. Since the scanned point cloud has a high density, it requires a lot of time to directly process the data. Actually, the points on the plane position can be sparser, and the points on the boundary and curvature can be denser, so the point cloud data can be performed sparsification through the curvature. A process of sparsification on the point cloud includes the following steps.

S221) For a point xᵢ in the point cloud data, a point set of a neighborhood of the point is defined as Xᵢ, where xⱼ∈Xᵢ; 1≤j≤n, n is the number of points in the point set of the neighborhood. An average curvature Qᵢ of the point xᵢ is calculated based on the point set Xᵢ of the neighborhood.

For the point xᵢ and the point set Xᵢ of the neighborhood, an average value Pᵢ of the average curvature Qᵢ is calculated according to the following formula:

$${P}_{i} = \frac{1}{n} {\sum }_{j = 1}^{n} {Q}_{j} ;$$

where Qⱼ is an average curvature of a point xⱼ in the point set Xᵢ of the neighborhood of the point xᵢ.

S222) An error φᵢ of a local average curvature is calculated according to the following formula:

$${φ}_{i} = {\sum }_{j = 1}^{n} \sqrt{\frac{{( {Q}_{j} - {P}_{i} )}^{2}}{n - 1}} ;$$

and an error threshold ε of the local average curvature is set.

S223) A corresponding retention time F and a calculation time S for each of points in the point cloud data is set.

S224) For the point xᵢ, if φᵢ≥ε, points with an average curvature Qⱼ≥λPᵢ in the point set Xᵢ of the neighborhood of the point xᵢ is retained, where is a set value. If φᵢ<ε, a point where an average curvature Qⱼ thereof is closest to the average value Pᵢ of the curvature average in the point set Xᵢ of the neighborhood of the point xᵢ is retained; the retention number of the retained points is cumulatively increased by 1 (Fⱼ=Fⱼ+1), and the calculation number of all points in the point set of the neighborhood is increased by 1 (Sⱼ=Sⱼ+1).

S225) The step S224 is repeatedly processed until all points are processed, and a reduction probability θ of each of points is calculated according to the following formula:

θ=Fᵢ/Sᵢ.

If the reduction probability of a point is greater than or equal to 0.5, the point is retained. If the reduction probability of a point is less than 0.5, the point is deleted.

S3) The preprocessed point cloud data of the wing and the preprocessed point cloud data of the center wing box are respectively registered with corresponding theoretical models.

The point cloud data is obtained by scanning with the scanner. The actual data and the ideal model are definitely different, but there is still a certain joining between the two. Operations such as alignment and feature extraction on the model are simpler than those on the point cloud, thus the point cloud data needs to be firstly registered with the model. Specifically, the point cloud data and the positioning points on the entity model at the same position are firstly extracted. The transformation matrix transformed from the positioning point of the point cloud data to the positioning point of the entity model is calculated by using the SVD algorithm. And then the point cloud data are transformed by using the transformation matrix. Finally, the transformed point cloud data and entity model are registered by using the ICP algorithm.

S4) The key features during joining on the two theoretical models are selected, and mapped to the registered point cloud data, and corresponding point cloud features are extracted.

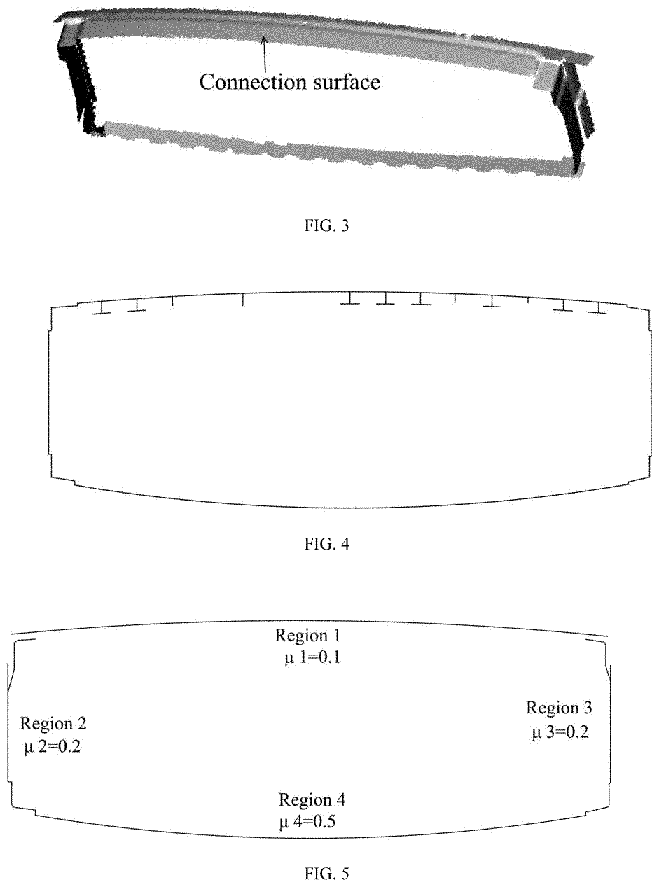

According to the simulated joining situation of the wing model and the entity model of the central wing box, the key features (positioning points and feature points of joining surface) during joining on the entity model are selected. Multiple sets of positioning points on the entity model are mapped to the point cloud data by using the registered point cloud data and the entity model in step S3, where each set of positioning points includes a positioning point of the wing and a positioning point of the central wing box, which are provided for joining the point cloud data of the wing and the point cloud data of the central wing box. In the registered point cloud data and entity model, for each point of the point cloud data, if there is a feature point of the entity model in its neighborhood, then the point is marked as the feature point of the point cloud data. After traversing all the points of the point cloud data, the feature point set of the joining surface is obtained, which is used for subtle transformation after the joining to control the gap distribution. FIG. 4 is a schematic diagram of the joining surface of the central wing box, and the joining surface can be divided into 4 areas.

S5) The point cloud data of the wing are docked with the point cloud data of the central wing box based on the positioning points.

S51) according to assembly positioning points of I set extracted in step S4, each set of assembly positioning points includes a positioning point Sᵢ of the wing and a positioning point Hᵢ of the central wing box, a positioning point gap after joining is a distance cᵢ between Sᵢ after transformation and Hᵢ, and cᵢ=∥(XSᵢ+Z)−Hᵢ∥. An objective function F is constructed as follows:

$$F = {min}_{X , Z} {\sum }_{i = 1}^{I} ‖ ( {XS}_{i} + Z ) - {H}_{i} ‖ ;$$

where Sᵢ is the positioning point of the wing; Hᵢ is the positioning point of the central wing box; X is a rotation matrix; Z is a translation matrix; and the corresponding X and Y are obtained by minimizing the objective function.

S52) A centroid S′ of the positioning point Sᵢ of the wing and a centroid H′ of the positioning point of the central wing box are respectively calculated as follows:

S′=Σᵢ₌₁^{I}Sᵢ;

H′=Σᵢ₌₁^{I}Hᵢ.

S53) All anchor points are moved, so that the centroids are moved to an original location: S′ᵢ=Sᵢ−S′, and H′ᵢ=Hᵢ−H′. The centriods are plugged into the objective function as:

$${F}_{2} = {min}_{X , Z} {\sum }_{i = 1}^{I} ‖ {H}_{i}^{′} - {XS}_{i}^{′} ) ‖ = {min}_{X , Z} {\sum }_{i = 1}^{I} \sqrt{{H}_{i}^{′ T} {H}_{i}^{′} + {S}_{i}^{′ T} {S}_{i}^{′} - 2 {H}_{i}^{′ T} {XS}_{i}^{′}} .$$

The minimum of F₂ is equivalent to the maximum of F:

F=Σᵢ₌₁^{I}H′ᵢ^{T}XS′ᵢ=Trace(XM);

where M=Σᵢ₌₁ⁿS′ᵢH′ᵢ^{T}.

S54) According to Lemma theorem, any positive definite matrix AA^{T} and an orthogonal matrix B satisfy: Trace(AA^{T})≥Trace(BAA^{T}). A singular value decomposition for M is processed, where M=UΛV^{T}; any 3×3 orthogonal matrix B satisfies: Trace(NM)≥Trace(BNM), that is, N makes F maximum and F₂ minimum. The rotation matrix is let to be X=N=ΛV^{T}.

S55) The translation matrix is calculated as: Z=H′−XS′.

S6) A gap of the feature points in each of the plurality of areas after joining is calculated, and a weight of each of the plurality of areas is adjusted according to gap tolerance to control the gap distribution.

After the alignment is completed in step S5, the weight is subtly adjusted to control the gap distribution according to the gap of the feature points, where the specific steps are as follows.

S61) The joining surface is divided into R areas, and the number of feature points in each of the areas is recorded as N, where Cₘₐₓ^{r} and Cₘᵢₙ^{r} are an upper gap tolerance and a lower gap tolerance of the feature point gap of the area r; 1≤r≤R. The upper and lower gap tolerance and the number of feature points are different in different areas. A gap value at a point in the area r is cᵣₙ, where 1≤n≤N, and Cₘᵢₙ^{r}≤∥cᵣₙ∥≤Cₘₐₓ^{r}. Feature points having a same weight in a same area are recorded as μᵣ, where the weight is related to the gap tolerance in the area. Let σᵣ=Cₘₐₓ^{r}−Cₘᵢₙ^{r}, then

$${μ}_{r} = \frac{1 / {σ}_{r}}{{\sum }_{1}^{R} 1 / {σ}_{r}} ,$$

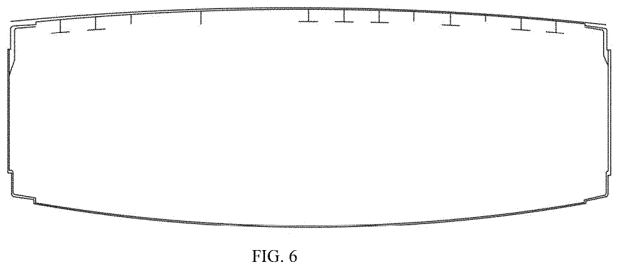

which is shown that the larger the gap tolerance is, the smaller the weight is. FIG. 5 is a schematic diagram of a weight distribution of a joining surface area of the wing.

S62) The point gap cᵣₙ of the feature point is defined as a projection length of a line, where the line is a projection of a line between the wing feature point Sₙ and the closest central wing box feature point Hₙ on the normal line of l(Hₙ), that is, cᵣₙ=∥l(Hₙ)·[Sₙ−Hₙ]∥.

S63) After joining, subtle transformation is performed to the wing feature points to control the gap. The current gap cᵣₙ can be expressed as: cᵣₙ=∥l(Hᵢ)·[(XSₙ+Z)−Hᵢ]+dZ·l(Hₙ)+dX·[Hₙ×l(Hₙ)]∥. The gap of the positioning point is transformed as cᵢ=∥X′(XSᵢ+Z)+Z′∥, where X and Z are joining transformation matrices; dX and dZ are relevant parameters of subtle transformation; X and Z′ are subtle transformation matrices, which are calculated with X, Z, dX and dZ. Weight constraints on the two gaps are performed to construct an error function F(X,Z,dX,dZ) as:

F(X,Z,dX,dZ)=Σᵢ₌₁^{I}μᵢ∥cᵢ∥+Σᵣ₌₁^{R}Σₙ₌₁^{N}μᵣ∥cᵣₙ∥=Σᵢ₌₁^{I}μᵢ∥dX(XSᵢ+Z)+dZ∥+Σᵣ₌₁^{R}Σₙ₌₁^{N}μᵣ∥l(Hᵢ)·[(XSₙ+Z)−Hᵢ]+dZ·l(Hₙ)+dX·[Hₙ×l(Hₙ)]∥;

An optimal pose evaluation model is constructed as:

min Σᵢ₌₁^{I}μᵢ∥cᵢ∥+Σᵣ₌₁^{R}Σₙ₌₁^{N}μᵣ∥cᵣₙ∥;

Cₘᵢₙ^{r}≤∥cᵣₙ∥≤Cₘₐₓ^{r};

where μᵢ is a weight of the positioning point; μᵣ is a weight of weight gap; I is the number of the set of the positioning points; R is the number of the areas in the joining surface; Cₘₐₓ^{r} and Cₘᵢₙ^{r} are an upper and lower gap tolerance of the feature point gap of the area r. An optimal transformation of X, Z, dX and dZ is solved by optimizing the model to obtain an optimal gap distribution under the current weight.

S64) If X and Z have no initial value, the X and the Z obtained in step S5 are adopted. Otherwise, the current X and Z are adopted. And the optimal pose evaluation model is calculated base on the PHR algorithm, to obtain dX and dZ.

S65) The subtle transformation matrix is calculated as:

X′=(E+dX)·X; Z′=(E+dX)·Z+dZ

where E is an unit matrix.

S66) Whether the gap requirement is satisfied or X′ and Z′ converge are determined. If the gap requirement is not satisfied and the X′ and the Z′ do not converge, then let X=X′, Z=Z′, and proceed to step S64. If the gap requirement is satisfied, then an optimal pose and an optimal gap distribution are calculated by using X′ and Z′, and stopping the process. If the gap requirement is satisfied but the X′ and the Z′ do not converge, then proceed to step S67.

S67) If there is only a gap exceeding the upper limit of the gap tolerance in an area, then the weight of the area is increased to reduce the gap. If there is only a gap below the lower limit of the gap tolerance in an area, then the weight of the area is reduced to increase the gap. If there is a gap exceeding the upper limit of the gap tolerance and a gap below the lower limit of the gap tolerance in an area at the same time in a certain area, then the weight of the area is maintained unchanged, the weight of the adjacent area of the feature points beyond the upper line in the area is reduced; and the weight of the adjacent area of the feature point below the lower line in the area is reduced. FIG. 6 shows a gap between the wing and the central wing box after subtle adjustment.

In this disclosure, various aspects of the present invention are described with reference to the accompanying drawings, in which numerous illustrated embodiments are shown. The embodiments of the present disclosure are not necessarily defined to include all aspects of the present disclosure. It should be understood that the various concepts and embodiments introduced above, as well as those described in more detail below, can be implemented in any of many ways, because the concepts and embodiments disclosed in the present invention are not limited to any implementation. In addition, some aspects disclosed in the present disclosure can be adopted alone or in any appropriate combination with other aspects disclosed in the present disclosure.

Although the present disclosure has been disclosed as above in preferred embodiments, they are not intended to limit the present invention. Those skilled in the art make various changes and modifications without departing from the spirit and scope of the present disclosure. Therefore, the protection scope of the present disclosure shall be subject to those defined by the appended claims.

What is claimed is:

1. A method for controlling a gap distribution of a wing-fuselage joining based on measured data, comprising:
S1) respectively collecting original point cloud data of a wing and original point cloud data of a central wing box of an aircraft;
S2) preprocessing the original point cloud data of the wing and the original point cloud data of the central wing box; performing operations of denoising, filtering and sparsification; and removing point cloud data that does not belong to joining surface between the wing and the central wing box;
S3) respectively registering the preprocessed point cloud data of the wing and the preprocessed point cloud data of the center wing box with corresponding theoretical models;
S4) according to a simulated joining situation of an entity model of the wing and a simulated joining situation of an entity model of the central wing box; selecting key features during joining on the two theoretical models; mapping the key features to the registered point cloud data; and extracting corresponding point cloud features, wherein the key features comprise positioning points and feature points of the joining surface;
S5) joining the point cloud data of the wing and the point cloud data of the central wing box based on the positioning points; and
S6) dividing the joining surface into a plurality of areas; calculating a gap of the feature points in each of the plurality of areas after joining; adjusting a weight of each of the plurality of areas according to gap tolerance to control the gap distribution; wherein the weight of each of the plurality of areas is inversely proportional to the gap tolerance thereof.

2. The method of claim 1, wherein a process of respectively collecting original point cloud data of the wing and original point cloud data of the central wing box of the aircraft in step S1 comprises:
S11) pasting code points and gauge points around the joining surface;
S12) obtaining coordinate information of the code points and the gauge points by using a photogrammetry technology, and establishing a scanning control field according to the obtained coordinate information;
S13) scanning the wing and the central wing box with a scanner to obtain the corresponding original point cloud data; and
S14) by combining with the scanning control field established in step S12, performing point cloud refinement on the original point cloud data of the wing and the original point cloud data of the central wing box to enhance a detailed description.

3. The method of claim 1, wherein a process of preprocessing the original point cloud data of the wing and the original point cloud data of the central wing box comprises:
S21) processing the original point cloud data through Gaussian filtering to remove noise and outliers, and extracting points belonging to the joining surface between the wing and the central wing box; and
S22) performing sparsification on the extracted points based on curvature.

4. The method of claim 3, wherein a process of performing sparsification on the extracted points based on curvature comprises:
S221) for a point xᵢ in the point cloud data, defining a point set of a neighborhood of the point as Xᵢ, wherein xⱼ∈Xᵢ; 1≤j≤n, and n is the number of points in the point set of the neighborhood; calculating an average curvature Qᵢ of the point xᵢ based on the point set Xᵢ of the neighborhood;
for the point xᵢ and the point set Xᵢ of the neighborhood, calculating an average value Pᵢ of the average curvature Qᵢ according to the following formula:
$${P}_{i} = \frac{1}{n} {\sum }_{j = 1}^{n} {Q}_{j} ;$$
wherein Qⱼ is an average curvature of a point xⱼ in the point set Xᵢ of the neighborhood of the point xᵢ;
S222) calculating an error φᵢ of a local average curvature according to the following formula:
$${φ}_{i} = {\sum }_{j = 1}^{n} \sqrt{\frac{{( {Q}_{j} - {P}_{i} )}^{2}}{n - 1}} ;$$
and setting an error threshold ε of the local average curvature;
S223) setting a corresponding retention time F and a calculation time S for each of points in the point cloud data;
S224) for the point xᵢ, if φᵢ≥ε, retaining a point with an average curvature Qⱼ≥λPᵢ in the point set Xᵢ of the neighborhood of the point xᵢ, wherein λ is a preset value; if φᵢ<ε, retaining a point where an average curvature Qⱼ thereof is closest to the average value Pᵢ of the curvature average in the point set Xᵢ of the neighborhood of the point xᵢ; increasing the retention number of the retained points cumulatively by 1 (Fⱼ=Fⱼ+1), and increasing the calculation number of all points in the point set of the neighborhood by 1 (Sⱼ=Sⱼ+1);
S225) repeatedly processing step S224 until all points are processed; calculating a reduction probability θ of each of points according to the following formula:
θ=Fᵢ/Sᵢ;
processing all point cloud data according to the reduction probability of each of points; if a reduction probability of a point is greater than or equal to 0.5, retaining the point; if a reduction probability of a point is less than 0.5, deleting the point.

5. The method of claim 1, a process of respectively registering the preprocessed point cloud data of the wing and the preprocessed point cloud data of the center wing box with the corresponding theoretical models comprises:
S31) respectively extracting part of or all of the positioning points corresponding to the theoretical models of the wing and the central wing box in the point cloud data;
S32) based on the singular value decomposition (SVD) algorithm, respectively calculating a transformation matrix from the positioning point of the wing in the point cloud data to the positioning point of corresponding entity model, and a transformation matrix from the point cloud data positioning point of the central wing box to the corresponding entity model positioning point;
S33) respectively transforming the point cloud data of the wing and the point cloud data of the center wing box by using the corresponding transformation matrices; and
S34) based on the iterative closest point (ICP) algorithm, respectively registering the point cloud data of the wing and the the point cloud data of the central wing box after transformed with their theoretical models.

6. The method of claim 1, wherein step S4 further comprises:
S41) according to simulated joining situations of the entity model of the wing and the entity model of the central wing box, selecting key features during joining on the entity model, wherein the key features comprises positioning points and feature points of the joining surface;
S42) mapping a plurality sets of positioning points on the two theoretical models to corresponding point cloud data by using the two sets of point cloud data and the theoretical models after registration in step S3; wherein each set of positioning points comprises at least one positioning point of the wing and at least one positioning point of the central wing box; and the positioning points are provided as a joining reference between the point cloud data of the wing and the point cloud data of the central wing box; and
S43) processing all points in the point cloud data, to obtain a feature point set of the joining surface for subtle transformation after joining to control the gap distribution; wherein, when there is at least one feature point of the joining surface of the entity model in an area of a point, the point is marked as a feature point of the joining surface.

7. The method of claim 1, wherein step S5 further comprises:
S51) according to positioning points of an I set of assembly extracted in step S4, assuming that positioning points of each set of assembly comprises a positioning point Sᵢ of the wing and a positioning point Hᵢ of the central wing box; a positioning point gap after joining is a distance cᵢ between Sᵢ after transformation and Hᵢ, and cᵢ=∥(XSᵢ+Z)−Hᵢ∥; and constructing an objective function F as:
$$F = {min}_{X , Z} {\sum }_{i = 1}^{I} ‖ ( {XS}_{i} + Z ) - {H}_{i} ‖ ;$$
wherein Sᵢ is the positioning point of the wing; Hᵢ is the positioning point of the central wing box; X is a rotation matrix; Z is a translation matrix; and the corresponding X and Y are obtained by minimizing the objective function;
S52) respectively calculating a centroid S′ of the positioning point Sᵢ of the wing and a centroid H′ of the positioning point of the central wing box as:
S′=Σᵢ₌₁^{I}Sᵢ;
H′=Σᵢ₌₁^{I}Hᵢ;
S53) moving all positioning points, so that the centroids are moved to an original location: S′ᵢ=Sᵢ−S′, and H′ᵢ=Hᵢ−H′; plugging the centriods into the objective function as:
$${F}_{2} = {min}_{X , Z} {\sum }_{i = 1}^{I} ‖ {H}_{i}^{′} - {XS}_{i}^{′} ) ‖ = {min}_{X , Z} {\sum }_{i = 1}^{I} \sqrt{{H}_{i}^{′ T} {H}_{i}^{′} + {S}_{i}^{′ T} {S}_{i}^{′} - 2 {H}_{i}^{′ T} {XS}_{i}^{′}} ;$$
the minimum of F₂ is equivalent to the maximum of F:
F=Σᵢ₌₁^{l}H′ᵢ^{T}XS′ᵢ=Trace(XM);
wherein M=Σᵢ₌₁ⁿS′ᵢH′ᵢ^{T};
S54) according to Lemma theorem, any positive definite matrix AA^{T} and an orthogonal matrix B satisfy: Trace(AA^{T})≥Trace(BAA^{T}); processing a singular value decomposition for M; wherein M=UΛV^{T}; any 3×3 orthogonal matrix B satisfies: Trace(NM)≥Trace(BNM), that is, N makes F maximum and F₂ minimum; letting the rotation matrix be X=N=ΛV^{T}; and
S55) calculating the translation matrix as: Z=H′−XS′.

8. The method of claim 7, wherein step S6 further comprises:
S61) dividing the joining surface into R areas; recording the number of feature points in each of the areas as N; wherein Cₘₐₓ^{r} and Cₘᵢₙ^{r} are respectively an upper gap tolerance and a lower gap tolerance of the feature point gap of an area r; 1≤r≤R; a gap value at a point in the area r is cᵣₙ; 1≤n≤N; Cₘᵢₙ^{r}≤∥cᵣₙ∥≤Cₘₐₓ^{r}; recording feature points having a same weight in a same area as μᵣ; wherein the weight is related to the gap tolerance in the area; letting σᵣ=Cₘₐₓ^{r}−Cₘᵢₙ^{r}, and
$${μ}_{r} = \frac{1 / {σ}_{r}}{{\sum }_{1}^{R} 1 / {σ}_{r}} ,$$
which is shown that the larger the gap tolerance is, the smaller the weight is;
S62) defining a gap cᵣₙ of the feature point as a projection length of a line, where the line is a projection of a line between the wing feature point Sₙ and the closest central wing box feature point Hₙ on a normal line of l(Hₙ), that is, cᵣₙ=∥l(Hₙ)·[Sₙ−Hₙ]∥;
S63) after joining, performing a subtle transformation for the feature points of the wing to control the gap; expressing the gap cᵣₙ as cᵣₙ=∥l(Hᵢ)·[(XSₙ+Z)−Hᵢ]+dZ·l(Hₙ)+dX·[Hₙ×l(Hₙ)]∥; transforming the gap of the positioning point as cᵢ=∥X′(XSᵢ+Z)+Z′∥; wherein X and Z are joining transformation matrices; dX and dZ are relevant parameters of subtle transformation; X′ and Z′ are subtle transformation matrices, which are calculated with X, Z, dX and dZ; performing weight constraints on the two gaps to construct an error function F(X,Z,dX,dZ) as:
F(X,Z,dX,dZ)=Σᵢ₌₁^{I}μᵢ∥cᵢ∥+Σᵣ₌₁^{R}Σₙ₌₁^{N}μᵣ∥cᵣₙ∥=Σᵢ₌₁^{I}μᵢ∥dX(XSᵢ+Z)+dZ∥+Σᵣ₌₁^{R}Σₙ₌₁^{N}μᵣ∥l(Hᵢ)·[(XSₙ+Z)−Hᵢ]+dZ·l(Hₙ)+dX·[Hₙ×l(Hₙ)]∥;
constructing an optimal pose evaluation model as:
min Σᵢ₌₁^{I}μᵢ∥cᵢ∥+Σᵣ₌₁^{R}Σₙ₌₁^{N}μᵣ∥cᵣₙ∥;
Cₘᵢₙ^{r}≤∥cᵣₙ∥≤Cₘₐₓ^{r};
wherein μᵢ is a weight of the positioning point; μᵣ is a weight of the gap; I is the number of the set of the positioning points; R is the number of the areas in the joining surface; Cₘₐₓ^{r} and Cₘᵢₙ^{r} are respectively an upper gap tolerance and a lower gap tolerance of the feature point gap of the area r;
Solving an optimal transformation of X, Z, dX and dZ by optimizing the model to obtain an optimal gap distribution under the current weight;
S64) if X and Z have no initial value, adopting the X and the Z obtained in step S5; otherwise, adopting the current X and the current Z; and calculating the optimal pose evaluation model base on the PHR algorithm, to obtain dX and dZ;
S65) calculating the subtle transformation matrix as:
X′=(E+dX)·X; Z′=(E+dX)·Z+dZ
wherein E is an unit matrix;
S66) determining whether the gap requirement is satisfied or X′ and Z′ converge; if the gap requirement is not satisfied and the X and the Z′ do not converge, then letting X=X′, Z=Z′, and proceeding to step S64; if the gap requirement is satisfied, then calculating an optimal pose and an optimal gap distribution by using the X′ and the Z′, and stopping the process; if the gap requirement is satisfied but the X′ and the Z′ do not converge, then proceeding to step S67; and
S67) adjusting a weight value according to a relationship between the gap of each area and the gap tolerance;
if there is only a gap exceeding the upper limit of the gap tolerance in an area, then increasing the weight of the area to reduce the gap; if there is only a gap below the lower limit of the gap tolerance in an area, then reducing the weight of the area to increase the gap; if there is a gap exceeding the upper limit of the gap tolerance and a gap below the lower limit of the gap tolerance in an area at the same time in a certain area, then maintaining the weight of the area unchanged; increasing the weight of the adjacent area of the feature points beyond the upper line in the area; and reducing the weight of the adjacent area of the feature point below the lower line in the area; and stopping the process.
